(19) United States
(12) Patent Application Publication
(10) Pub. No.: US 2015/0375116 A1
(43) Pub. Date: Dec. 31, 2015

(54) GAME TERMINAL DEVICE

(71) Applicant: GungHo Online Entertainment, Inc., Chiyoda-ku (JP)

(72) Inventor: Kazuki MORISHITA, Chiyoda-ku (JP)

(73) Assignee: GungHo Online Entertainment, Inc., Chiyoda-ku (JP)

(21) Appl. No.: 14/617,074

(22) Filed: Feb. 9, 2015

(30) Foreign Application Priority Data
Jun. 27, 2014 (JP) 2014-132153

(51) Int. Cl. A63F 13/537

(52) U.S. Cl. CPC A63F 13/537

(57) ABSTRACT

[Problem] To provide an effective terminal device devised so as to enable a player to gain enhanced enjoyment from a game.

[Solution] A terminal device according to an embodiment of the present invention is provided with: a storage unit storing, in association with individual unit games, completion information indicating whether or not the unit game has been completed; an input unit acquiring operation information indicating specifics of an operation performed by a player; and a display controller for controlling displaying of a specific character in accordance with a first mode in which an action of the specific character is controlled on the basis of the operation information or a second mode in which the action of the specific character is controlled on the basis of the operation information at a frequency lower than that in the first mode, the display controller enabling utilization of the second mode on the basis of the completion information corresponding to a specific unit game during execution of the specific unit game.

### CROSS-REFERENCE TO RELATED APPLICATION

This application is based upon and claims priority under 35 U.S.C. §119 to Japanese Patent Application No. 2014-132153 filed on Jun. 27, 2014, entitled “GAME TERMINAL DEVICE”, the entire contents of which are hereby incorporated herein by reference.

### FIELD

The disclosed technology relates to a game terminal device and the like for allowing a player to experience a game.

### BACKGROUND

Known game terminal devices according to conventional techniques include that disclosed in JP-A 2010-201180 (hereafter referred to as “Patent Reference 1”. The entire contents of which are hereby incorporated herein by reference.). The game terminal device disclosed in Patent Reference 1 is one in which normal mode, in which the action of a specific character is controlled on the basis of operation information indicating the specifics of an operation performed by the player, and auto mode, in which the action of the specific character is controlled in a manner that is not based on the operation information, are used.

### PRIOR ART REFERENCES

### Patent References

Patent Reference 1: Japanese Laid-Open Patent Application 2010-201180

### SUMMARY

However, Patent Reference 1 contains no disclosure of a method for effectively using auto mode so as to enable the player to enjoy the game.

Accordingly, the present invention, through a variety of embodiments, provides an effective terminal device devised as to enable a player to gain enhanced enjoyment from a game.

A terminal device according to an embodiment of the present invention is provided with: a storage unit storing, in association with individual unit games, completion information indicating whether or not the unit game has been completed; an input unit acquiring operation information indicating specifics of an operation performed by a player; and a display controller controlling displaying of a specific character in accordance with a first mode in which an action of the specific character is controlled on the basis of the operation information or a second mode in which the action of the specific character is controlled on the basis of the operation information at a frequency lower than that in the first mode, the display controller enabling utilization of the second mode on the basis of the completion information corresponding to a specific unit game during execution of the specific unit game.

A server device according to an embodiment of the present invention is provided with: a storage unit storing, in association with individual unit games, completion information indicating whether or not the unit game has been completed; an input unit acquiring operation information indicating specifics of an operation performed by a player; and a display controller controlling displaying of a specific character in accordance with a first mode in which an action of the specific character is controlled on the basis of the operation information or a second mode in which the action of the specific character is controlled on the basis of the operation information at a frequency lower than that in the first mode, the display controller enabling utilization of the second mode on the basis of the completion information corresponding to a specific unit game during execution of the specific unit game.

A non-transitory computer-readable medium in which a computer program according to an embodiment of the present invention is stored, the computer program characterized in causing a computer to function as: a storage unit storing, in association with individual unit games, completion information indicating whether or not the unit game has been completed; an input unit acquiring operation information indicating specifics of an operation performed by a player; and a display controller controlling displaying of a specific character in accordance with a first mode in which an action of the specific character is controlled on the basis of the operation information or a second mode in which the action of the specific character is controlled on the basis of the operation information at a frequency lower than that in the first mode, the display controller enabling utilization of the second mode on the basis of the completion information corresponding to a specific unit game during execution of the specific unit game.

A game display method according to an embodiment of the present invention includes: a step for storing, in association with individual unit games, completion information indicating whether or not the unit game has been completed; a step for acquiring operation information indicating specifics of an operation performed by a player; and a step for controlling displaying of a specific character in accordance with a first mode in which an action of the specific character is controlled on the basis of the operation information or a second mode in which the action of the specific character is controlled on the basis of the operation information at a frequency lower than that in the first mode, the step enabling utilization of the second mode on the basis of the completion information corresponding to a specific unit game during execution of the specific unit game.

According to a variety of embodiments of the present invention, it is possible to provide an effective terminal device devised so as to enable a player to gain enhanced enjoyment from a game.

### BRIEF DESCRIPTION OF THE DRAWINGS

FIG. 1 is a block diagram schematically illustrating a game system according to an embodiment of the present invention;

FIG. 2 is a block diagram schematically illustrating the architecture of a terminal device 30 according to an embodiment of the present invention;

FIG. 3 is a block diagram illustrating functions of a server device 10 according to an embodiment of the present invention;

FIG. 4 is a table showing a specific example of information stored in cleared information used in a game system according to an embodiment of the present invention;

FIG. 5 is a flow chart illustrating the manner in which a game is provided in a game system according to an embodiment of the present invention;

FIG. 6 illustrates an example of a screen image displayed on a display unit of a terminal device 30 (or a display unit connected to the terminal device 30) in a game system according to an embodiment of the present invention;

FIG. 7 illustrates an example of a screen image displayed on a display unit of the terminal device 30 (or a display unit connected to the terminal device 30) in a game system according to an embodiment of the present invention;

FIG. 8A is a flow chart illustrating an algorithm used when executing the auto mode in a game system according to an embodiment of the present invention; and

FIG. 8B is a flow chart illustrating an algorithm used when executing the auto mode in a game system according to an embodiment of the present invention.

### DETAILED DESCRIPTION

A variety of embodiments will now be described with reference to the accompanying drawings as appropriate. Constituent elements that are common between drawings are affixed with the same numerals.

First, a description will be given for an embodiment in which a terminal device receives provision of a game service from a server device through a communication line as a typical embodiment. However, the present invention is not limited by the embodiment, and includes a variety of embodiments such as that in which the terminal device provides a game service to a player on the basis of a program installed on the terminal device without or while communicating with the server device.

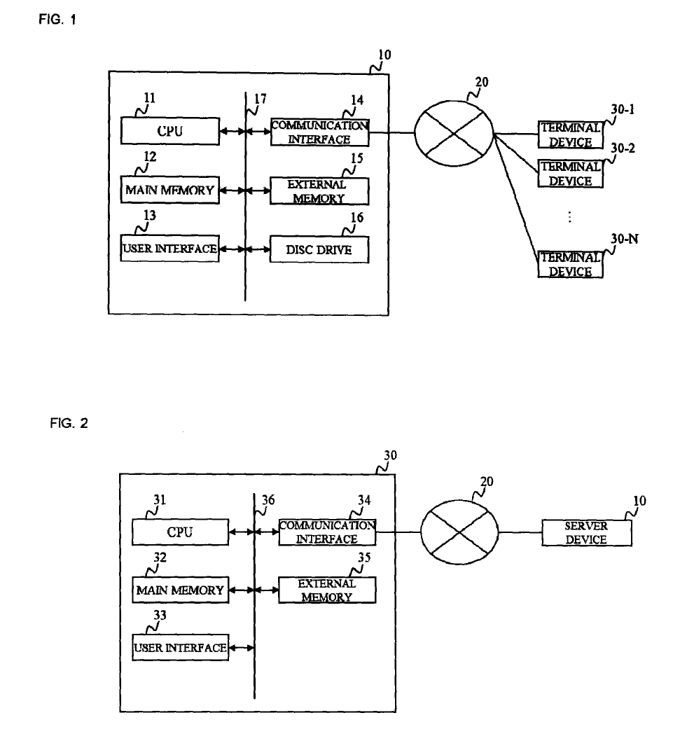

FIG. 1 is a block diagram schematically illustrating a game system according to an embodiment of the present invention. As shown in FIG. 1, an online game server device 10 (may hereafter be referred to simply as “server device 10”) according to the embodiment of the present invention is communicably connected over the Internet or another communication network 20 to a plurality of terminal devices 30 30-1, 30-2, . . . , 30-N (may hereafter be collectively referred to as “terminal devices 30”) provided with a communication function. The server device 10 is an example of a device installed with some or all of a game system according to the embodiment of the present invention.

As shown, the server device 10 includes a CPU 11, a main memory 12, a user interface 13, a communication interface 14, an external memory 15, and a disc drive 16, and the above constituent elements are electrically connected to each other over a bus 17. The CPU 11 loads a variety of programs for controlling the progress of an online game and the operating system from the external memory 15 to the main memory 12, and executes commands included in the program. The main memory 12 is used to store the programs executed by the CPU 11, and comprises, e.g., a DRAM.

The user interface 13 includes, e.g., an information input device such as a keyboard or a mouse for receiving operator input, and an information output device such as a liquid crystal display for outputting the results of computations by the CPU 11. The communication interface 14 is installed as hardware, firmware, communication software such as a TCP/IP driver or a PPP driver, or a combination thereof, and is configured so as to be capable of communicating with the terminal devices 30 over the communication network 20.

The external memory 15 comprises, e.g., a magnetic disc drive, and stores a variety of programs such as a control program for controlling the progress of the online game. A variety of data used in the game may also be stored in the external memory 15.

The disc drive 16 reads data stored in a variety of storage media such as a CD-ROM, a DVD-ROM, or a DVD-R, or writes data onto the storage media. For example, data such as a game application or game data stored in a storage medium is read by the disc drive 16 and installed on the external memory 15.

In the embodiment, the server device 10 is a web server for managing a website comprising a plurality of web pages having a hierarchical structure, and is capable of providing a game service to the terminal devices 30. Browser software provided to each of the terminal devices 30 is capable of acquiring HTML data for displaying a web page from the server device 10, analyzing the acquired HTML data, and presenting the web page to the user of the terminal device 30 (i.e., the game player). A game of such description provided though a web page displayed by browser software may be referred to as a browser game. HTML data for displaying the web page may also be stored in the external memory 15. The HTML data comprises a HTML document written in a markup language such as HTML, and a variety of images may be associated with the HTML document using a tag. A program such as that written in a script language such as ActionScript™ or JavaScript™ may also be embedded in the HTML document.

A game application executed in the terminal devices 30 in an execution environment other than the browser software may also be stored in the external memory 15. The game application may include a variety of data such as a game program for executing the game or image data referenced during execution of the game program. The game program is created in an object-oriented programming language such as Objective-C™ and Java™. The created game program is stored in the external memory 15 as application software together with the data. The application software stored in the external memory 15 is distributed to a terminal device 30 in response to a distribution request. The application software distributed by the server device 10 is received by the terminal device 30 via a communication interface 34 according to a control performed by a CPU 31, and the received game program is transmitted to and stored in an external memory 35. The application software is launched in response to an operation performed by the player on the terminal device 30 and executed on a platform such as NgCore™ or Android™ installed on the terminal device 30. The server device 10 provides a variety of data necessary for the game to proceed to the game application being executed by the terminal device 30. The server device 10 also stores, with respect to each of the players, a variety of data transmitted from the terminal devices 30, and can thereby manage the progress of the game with respect to each of the players.

Thus, the server device 10 manages the website providing a game service, and is capable of distributing a web page constituting the website in response to a request from a terminal device 30 and thereby causing the game to proceed. The server device 10 is also capable of communicating a game application executed by the terminal device 30 and a variety of data used in the game and thereby causing the game to proceed, instead of or in addition to a browser game of above description. Irrespective of which of the formats the game is provided in, the server device 10 is capable of storing data necessary for the game to proceed for each identification information (described further below) identifying each of the players. The games provided by the server device 10 include any arbitrary game such as an action game, a role-playing game, a baseball battle game, or a card game. The type of game realized through the game application or the website using the server device 10 is not limited to those set forth herein.

The terminal devices 30 are, in one embodiment, arbitrary information processing devices capable of displaying the web pages of the game website acquired from the server device 10 on a web browser, and include, e.g., tablets, mobile telephones, smartphones, game consoles, personal computers, touchpads, or electronic book readers, but are not limited to the above. In another embodiment, the terminal devices 30 are arbitrary information processing devices installed with an application execution environment for executing a game application.

The architecture of the terminal devices 30 will now be described with reference to FIG. 2. FIG. 2 is a block diagram schematically illustrating the architecture of a terminal device 30 according to an embodiment of the present invention. As shown, the terminal device 30 includes the CPU 31, a main memory 32, a user interface 33, the communication interface 34, and the external memory 35, and the above constituent elements are electrically connected to each other over a bus 36.

The CPU 31 loads a variety of programs such as an operating system from the external memory 35 into the main memory 32 and executes commands included in the loaded program. The main memory 32 is used to store the programs executed by the CPU 31, and comprises, e.g., a DRAM.

The user interface 33 includes, e.g., an information input device such as a touch panel, a keyboard, a button, or a mouse for receiving player (user) input, and an information output device such as a liquid crystal display for outputting the results of computations by the CPU 31. The communication interface 34 is installed as hardware, firmware, communication software such as a TCP/IP driver or a PPP driver, or a combination thereof, and is configured so as to be capable of communicating with the terminal device 10 over the communication network 20.

The external memory 35 comprises, e.g., a magnetic disc drive or a flash memory, and has a variety of programs such as the operating system stored therein. In addition, when a game application is received from the server device 10 through the communication interface 34, the received game application is stored in the external memory 35.

A terminal device 30 having an architecture of such description is provided with browser software for interpreting, e.g., a HTML-format file (HTML data) and displaying a screen image. The function of the browser software makes it possible for the terminal device 30 to interpret the HTML data acquired from the server device 10 and display a web page corresponding to the received HTML data. The terminal device 30 is also provided with plug-in software (e.g., FLASH™ Player provided by Adobe Systems) incorporated in the browser software, and is capable of acquiring a SWF-format file embedded in the HTML data from the server device 10 and execute the SWF-format file using the browser software and the plug-in software.

When the game is executed in the terminal device 30, e.g., animation or an operation icon as instructed by the program is displayed on a screen of the terminal device 30. The player is able to input instructions for proceeding with the game using an input interface (e.g., a touch screen or a button) of the terminal device 30. The instruction inputted by the player is transmitted to the server device 10 through the function of a platform such as NgCore™ or the browser on the terminal device 30.

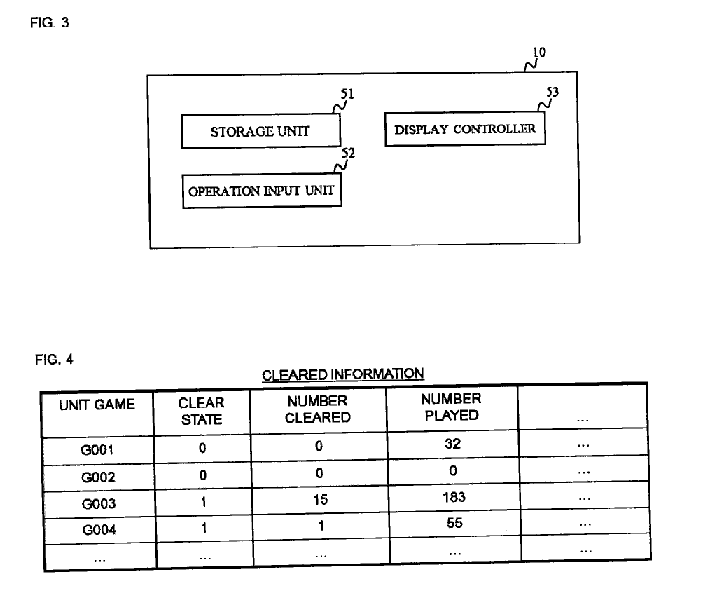

Next, a description will be given for the function of the server device 10 realized by the constituent elements shown in FIG. 1 with reference to FIG. 3. FIG. 3 is a block diagram illustrating functions of the server device 10 according to an embodiment of the present invention. As shown in FIG. 3, the server device 10 mainly includes a storage unit 51, an operation input unit 52, and a display controller 53.

The storage unit 51 stores, with respect to each of the players, cleared information (completion information) indicating whether or not each unit game has been cleared (completed) in association with the respective unit game. A “unit game” herein represents a block within a game, and is expressed as, e.g., a quest, a scenario, a chapter, a dungeon, or a mission. The cleared information stored in the storage unit 51 is information identifying which of the large number of available unit games has been cleared by each of the players and which of the unit games has not yet been cleared by each of the players.

FIG. 4 is a table showing a specific example of information stored in cleared information used in a game system according to an embodiment of the present invention. In FIG. 4, information expressed as “G001” to “G004” shown in the “unit game” fields is identification information uniquely allocated to each of the unit games. In the “clear state” fields, “0” indicates that the corresponding unit game is in an uncleared state, and “1” indicates that the corresponding unit game is in an already cleared state. The “number cleared” fields show the number of times the corresponding unit game has been cleared. The “number played” fields show the number of times the corresponding unit game has been played. The cleared information can store information of such description with respect to each of the players (note that FIG. 4 only shows, as an example, cleared information relating to one player).

With reference to FIG. 3 again, the operation input unit 52 acquires operation information indicating the specifics of an operation performed by the player on (the user interface 33 of) the terminal devices 30. The operation input unit 52 acquires operation information indicating the specifics of a variety of operations, including, e.g., an operation performed on an operation button or a keyboard available on the terminal device 30 and/or an operation performed on an icon displayed on a display unit of the terminal device 30 (or a display unit connected to the terminal device 30) by the player.

The display controller 53 controls displaying of a specific character on the display unit of the terminal device 30 (or the display unit connected to the terminal device 30) in accordance with the operation information acquired by the operation input unit 52. The specific character includes a character that is caused to perform an action as instructed by the player. Specifically, in normal mode (first mode), the display controller 53 controls the action of the specific character on the basis of the operation information, and in auto mode (second mode), the display controller 53 controls the action of the specific character on the basis of the operation information at a lower frequency than that used in normal mode. In auto mode, the display controller 53 can also control the action of the specific character according to an algorithm, which has been prepared in advance, without depending on the operation information, or control the action of the specific character according to an algorithm, which has been prepared in advance, so as to partially depend on the operation information.

The display controller 53 may, when a unit game is played by the player, also make it possible to employ auto mode (allowed to shift from normal mode to auto mode) during execution of the unit game only when the unit game has already been cleared by the player.

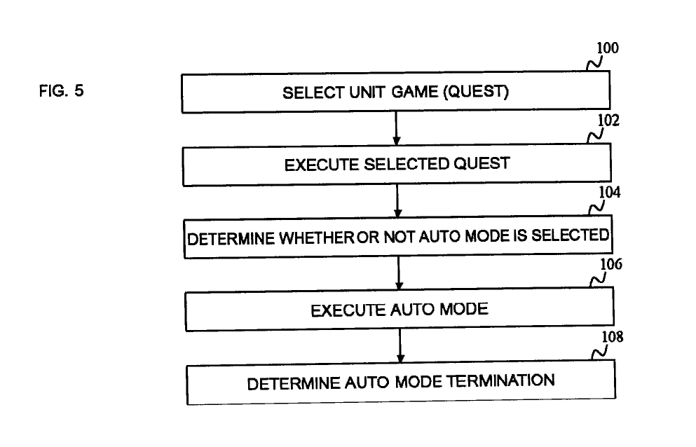

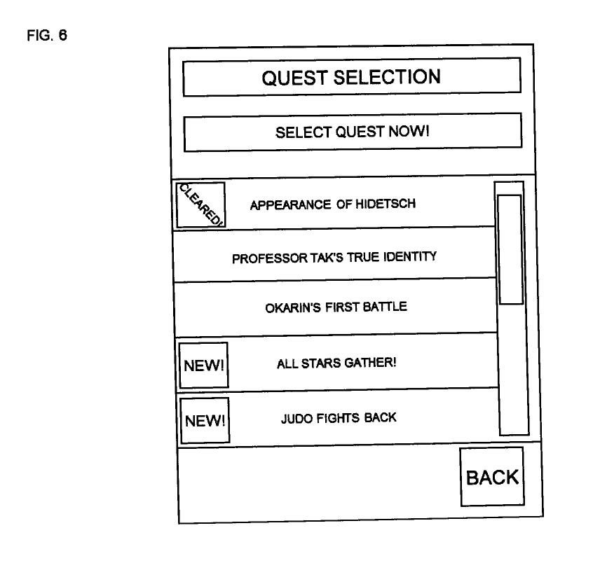

Next, a description will be given for the manner in which a game is provided to the terminal devices 30 in a game system having the above configuration with reference to FIG. 5. FIG. 5 is a flow chart illustrating the manner in which a game is provided in a game system according to an embodiment of the present invention.

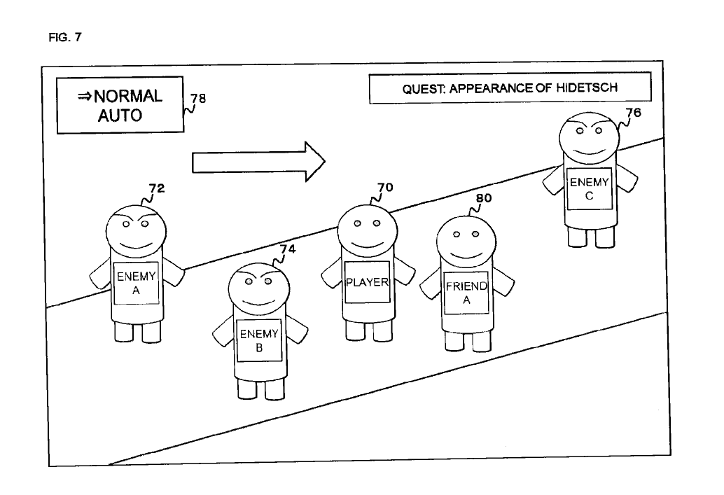

First, in step (hereafter referred to as “ST”) 100, the player selects, through the terminal device 30, the unit game (quest) to be played. FIG. 6 illustrates an example of a screen image displayed on a display unit of a terminal device 30 (or a display unit connected to the terminal device 30) in the game system according to an embodiment of the present invention. As can be seen in FIG. 6, quests that the player has not yet played (e.g., quests entitled “All Stars Gather!” and “Judo Fights Back”) are indicated by display of the word “NEW!” Quests that the player has cleared and that for which auto mode can therefore be employed (e.g., the quest entitled “The Appearance of Hidecchi”) are indicated by display of the word “Cleared!” The player is thereby able to identify, for each of the quests, whether auto mode can be employed.

Next, in ST102, the selected quest is executed. FIG. 7 illustrates an example of a screen image displayed on a display unit of the terminal device 30 (or a display unit connected to the terminal device 30) in a game system according to an embodiment of the present invention. FIG. 7 shows an example in which a quest (in this example, the quest entitled “The Appearance of Hidecchi” selected in FIG. 6) is being executed in an action role-playing game which scrolls rightwards. The player is able to move a specific character 70 in an arbitrary direction and attack enemy characters (in FIG. 7, enemy character (enemy A) 72, enemy character (enemy B) 74, and enemy character (enemy C) 76, as an example) which perform actions linked to the specific character 70.

With reference to FIG. 5 again, in ST104, it is determined whether or not auto mode has been selected. Specifically, first, if the quest being executed has already been cleared by the player (which is identified from the cleared information described further above), the server device 10 displays on the terminal device 30 to indicate this fact. For example, as shown in icon 78 in FIG. 7, the server device 10 displays on the terminal device 30 that either of normal mode (NORMAL) and auto mode (AUTO) can be selected (conversely, if the quest being executed has not yet been cleared by the player, the server device 10 may display the word NORMAL alone on the icon 78 in FIG. 7).

If the player performs an operation to execute auto mode, the process proceeds to ST106, and if the player does not perform an operation to execute auto mode, the process returns to ST102 described further above.

In ST106, the server device 10 shifts from normal mode to auto mode and executes auto mode. In auto mode, the server device 10 controls the action of the specific character 70 without depending on the operation information. For example, the server device 10 may control the action of the specific character 70 so as to launch an attack beginning with the enemy character, from among the enemy characters displayed on the screen image, that is nearest (or furthest) from the specific character 70. With reference to FIG. 7, the server device 10 is able to achieve this control through calculating the distance between each of the enemy characters and the specific character using the coordinates of each of the enemy characters displayed on the screen image and the coordinates of the specific character 70.

In another embodiment, in auto mode, the server device 10 is able to control the action of the specific character 70 and/or the enemy characters 72, 74, 76 in a manner that is based on the number of times the quest being executed has been cleared by the player. For example, the server device 10 is able to control the action (attacking power) of the specific character 70 so that the damage done to the enemy characters 72, 74, 76 by the specific character 70 is proportional to the number of times that the quest has been cleared by the player (i.e., the attacking power of the specific character 70 increases with the number of times that the quest has been cleared). Alternatively, e.g., the server device 10 may control the action of the specific character 70 or the enemy characters 72, 74, 76 so that the speed of movement of the specific character 70 is proportional to the number of times the quest has been cleared and/or the speed of movement of the enemy characters 72, 74, 76 is inversely proportional to the number of times the quest has been cleared.

In yet another embodiment, in auto mode, the server device 10 controls the action of the specific character 70 so as to partially depend on the operation information. As a first example, in auto mode, the player is able to solely determine, through the terminal device 30, which of the enemy characters to attack. In response, the server device 10 controls the action of the specific character 70 so as to attack the enemy character determined on the basis of the operation information acquired from the terminal device 30. In such an instance, the server device 10 is able to control the movement of the specific character 70 (i.e., the direction in which the specific character 70 is to be moved) without depending on the operation information, in accordance with a predetermined algorithm.

As a second example, in auto mode, the player is able to solely determine, through the terminal device 30, the direction in which to move the specific character 70. In response, the server device 10 controls the action of the specific character 70 so as to move in the direction determined on the basis of the operation information acquired from the terminal device 30.

As a third example, in auto mode, the player is able to solely determine, through the terminal device 30, which of the skills (such as a special attack, defense, or recovery skill) held by the specific character 70 to exert. In response, the server device 10 controls the action of the specific character 70 so as to exert the skill selected on the basis of the operation information acquired from the terminal device 30.

The first through third examples may be used in combination with each other.

In ST108, the server device 10 determines whether or not to terminate auto mode and shift to normal mode. For example, if the player performs an operation through the terminal device 30 to terminate auto mode (e.g., taps or clicks the icon 78 shown in FIG. 7), the server device 10 terminates auto mode and shifts to normal mode, and the process returns to ST102. Conversely, if the player does not perform an operation to terminate auto mode, the process returns to ST106, and the server device 10 maintains auto mode.

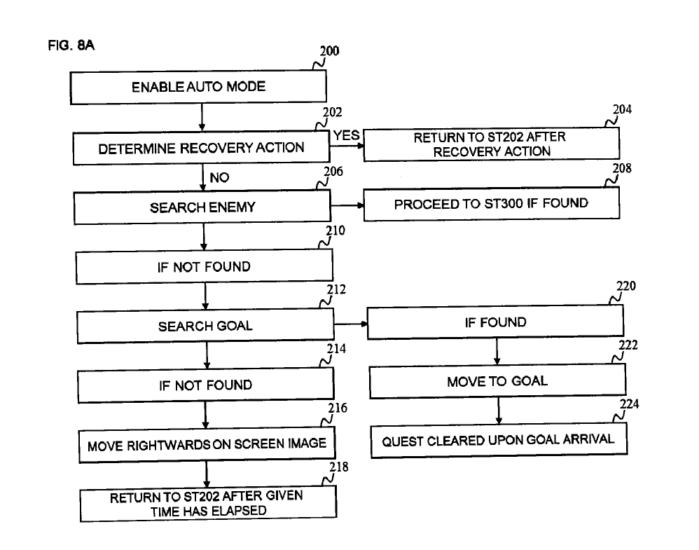

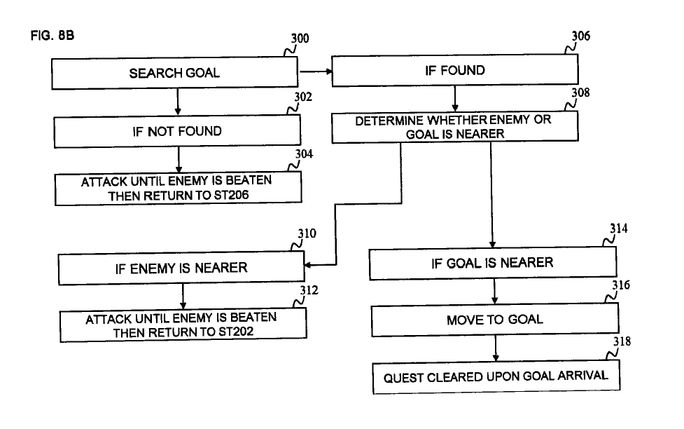

Next, a description will be given for the algorithm according to which the server device 10 controls the action of the specific character in auto mode with reference to FIGS. 8A and 8B. FIGS. 8A and 8B are flow charts illustrating an algorithm used when executing the auto mode in a game system according to an embodiment of the present invention.

In ST200, the server device 10 enables auto mode. In ST202, the server device 10 determines whether or not to cause the specific character 70 to perform a recovery action (only applicable to cases in which the specific character 70 possesses a recovery skill). Specifically, the server device 10 determines, if, e.g., the hit point (energy value) of a character 80, who is a friend of the specific character 70, is 70% or less, whether or not to cause the specific character 70 to perform a recovery action. In this instance, the server device 10 determines whether or not to perform a recovery action according to a probability (e.g., 10%) determined in advance.

If the server device 10 determines that a recovery action is to be performed, the server device 10 causes the specific character 70 to perform a recovery action in ST204 and the process returns to ST202. Conversely, if the server device 10 determines that a recovery action is to not be performed, the process proceeds to ST206.

In ST206, the server device 10 searches for an enemy of the specific character 70. Specifically, the server device 10 searches for an enemy according to, e.g., the following probabilities determined in advance.

Enemy with good attribute compatibility—30%

Enemy with a large number of remaining hit points—20%

Enemy with a small number of remaining hit points—10%

Enemy positioned at a short distance—20%

Enemy positioned at a long distance—10% Enemy in an abnormal state—10%

If an enemy of the specific character 70 is successfully searched (ST208), the process of the server device 10 proceeds to ST300 (described further below). If no enemy of the specific character 70 is discovered (ST210), the process of the server device 10 proceeds to ST212.

In ST212, the server device 10 searches for a goal. If no goal is found (ST214), the server device 10 moves, in ST216, the specific character 70 rightwards on the screen image (i.e., in the forward direction), and stands by until a given time has passed (ST218), and the process returns to ST202. Conversely, if a goal is found (ST220), the server device 10 moves the specific character 70 towards the goal (ST222). The player is thereby able to clear the quest (ST224).

If an enemy has been found (ST208) as a result of the search for an enemy in ST206, the server device 10 searches for a goal in ST300. If no goal has been found (ST302), the server device 10 causes the specific character 70 to attack until the enemy is beaten (ST304), and the process then returns to ST206. In ST304, the server device 10 may cause the specific character 70 to attack the enemy according to, e.g., the following probabilities determined in advance.

1. If the enemy is positioned at a short distance (2.5 m)

Standby—5%

Move—5%

Attack—65%

Guard—0%

Use attack skill—25%

2. If the enemy is positioned at an intermediate distance (4.5 m)

Standby—5%

Move—10%

Attack—60%

Guard—0%

Use attack skill—25%

3. If the enemy is positioned at a long distance (7 m)

Standby—5%

Move—10%

Attack—70%

Guard—0%

Use attack skill—20%

4. If the enemy is positioned at a very long distance (15 m)

Standby—0%

Move—0%

Attack—100%

Guard—0%

Use attack skill—0%

With regards to ST304, it is also possible to use an additional algorithm in which once a given time has elapsed since the specific character 70 has started attacking the enemy, the specific character 70 is caused to perform the recovery action determination indicated in ST202 (and if YES, the recovery action indicated in ST204) and then maintain the attack in ST304 (without newly searching for an enemy). This is to prevent the hit point from continuing to decrease with the specific character 70 attacking the enemy. An additional algorithm of such description can also be applied to ST312 described further below.

If a goal is found (ST306) as a result of searching for a goal in ST300, the server device 10 determines whether the enemy or the goal is nearer (ST308). If it is determined that the enemy is nearer (ST310), the server device 10 causes the specific character 70 to attack until the enemy is beaten (ST312), and the process then returns to ST202. The probabilities used in ST312 may be the same as those used in ST304.

If it is determined that the goal is nearer (ST314), the server device 10 moves the specific character 70 to the goal (ST316). The player is thereby able to clear the quest (ST318).

As described above, according to a variety of embodiments of the present invention, during execution of a unit game, a shift to auto mode is enabled on the basis of whether or not the unit game has been cleared by the player, thereby making it possible to effectively utilize auto mode and to therefore improve the enjoyment of playing the game. Specifically, compared to a case in which auto play is always possible unconditionally in any unit game, in a variety of embodiments, utilization of auto mode during execution of a unit game is only made possible when the unit game has been cleared at least once in the past, making it possible for the user to gain further enjoyment (e.g., enjoyment of overcoming difficulties and clearing the unit game) when first playing the unit game. Auto play in a unit game that has already been cleared may also be utilized by the player as means for accumulating experience values used to beat a strong enemy appearing in another unit game.

When executing a unit game that has not yet been cleared, the player is unable to utilize auto mode, and must therefore clear the unit game on his/her own. The desire of the game manufacturing side for a player to play a new unit game on his/her own at least once is also satisfied.

A description was given above for a variety of embodiments in which a game is played using a terminal device. However, the present invention can also be similarly applied to instances in which a learning program or the like is executed by a terminal device. Specifically, the present invention may be such that, e.g., when a user has completed a specific mission including a listening lesson, a writing lesson, a speaking lesson, and the like a predetermined number of times in a scenario in which an English language learning program is executed by a terminal device, and repeats the specific lesson, the specific mission may be executed on the basis of an input operation performed by the user so that the frequency of at least one of the above lessons is lower.

As described above, according to a variety of embodiments of the present invention, it is possible to provide an effective terminal device devised so as to enable a player to gain enhanced enjoyment from the game.

### EXPLANATION OF NUMERALS AND CHARACTERS

10 Server device
30 Terminal device
51 Storage unit
52 Operation input unit
53 Display controller

1. A terminal device comprising:
a storage unit storing, in association with individual unit games, completion information indicating whether or not the unit game has been completed;
an input unit acquiring operation information indicating specifics of an operation performed by a player; and
a display controller controlling displaying of a specific character in accordance with a first mode in which an action of the specific character is controlled on the basis of the operation information or a second mode in which the action of the specific character is controlled on the basis of the operation information at a frequency lower than that in the first mode, the display controller enabling utilization of the second mode on the basis of the completion information corresponding to a specific unit game during execution of the specific unit game.

2. The terminal device according to claim 1, wherein
the display controller enables utilization of the second mode during execution of the specific unit game only when the completion information corresponding to the specific unit game indicates that the specific unit game has been completed a predetermined number of times.

3. The terminal device according to claim 1, wherein in the second mode, the display controller controls, in a manner corresponding to the number of times the specific unit game has been completed, the action of the specific character and/or an enemy character which performs an action linked to the specific character.

4. The terminal device according to claim 1, wherein the display controller determines, in the second mode, a specific action from among actions of the specific character on the basis of the operation information.

5. The terminal device according to claim 4, wherein the specific action is at least one of:
a movement in an arbitrary direction;
a selection pertaining to which skill, from among a plurality of skills, to be exert; and
a selection pertaining to which enemy character, from among a plurality of enemy characters performing an action linked to the specific character, to be attack.

6. A server device comprising:
a storage unit storing, in association with individual unit games, completion information indicating whether or not the unit game has been completed;
an input unit acquiring operation information indicating specifics of an operation performed by a player; and
a display controller for controlling displaying of a specific character in accordance with a first mode in which an action of the specific character is controlled on the basis of the operation information or a second mode in which the action of the specific character is controlled on the basis of the operation information at a frequency lower than that in the first mode, the display controller enabling utilization of the second mode on the basis of the completion information corresponding to a specific unit game during execution of the specific unit game.

7. A non-transitory computer-readable medium in which a computer program is stored, the computer program characterized in causing a computer to function as:
a storage unit storing, in association with individual unit games, completion information indicating whether or not the unit game has been completed;
an input unit acquiring operation information indicating specifics of an operation performed by a player; and
a display controller controlling displaying of a specific character in accordance with a first mode in which an action of the specific character is controlled on the basis of the operation information or a second mode in which the action of the specific character is controlled on the basis of the operation information at a frequency lower than that in the first mode, the display controller enabling utilization of the second mode on the basis of the completion information corresponding to a specific unit game during execution of the specific unit game.

8. A game display method, characterized in including:
a step for storing, in association with each unit game, completion information indicating whether or not the unit game has been completed;
a step for acquiring operation information indicating specifics of an operation performed by a player; and
a step for controlling displaying of a specific character in accordance with a first mode in which an action of the specific character is controlled on the basis of the operation information or a second mode in which the action of the specific character is controlled on the basis of the operation information at a frequency lower than that in the first mode, the step enabling utilization of the second mode on the basis of the completion information corresponding to a specific unit game during execution of the specific unit game.
